(19) United States
(12) Patent Application Publication
(10) Pub. No.: US 2009/0234535 A1
(43) Pub. Date: Sep. 17, 2009

(54) METHOD AND APPARATUS FOR OPERATING A DIGITAL TACHOGRAPH AND A DATA STORAGE MEDIUM

(76) Inventors: Roland Lange, Brigachtal (DE); Andreas Lindinger, Flözlingen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/301,052

(22) PCT Filed: May 10, 2007
(86) PCT No.: PCT/EP2007/054507

§ 371 Date: Nov. 17, 2008

(30) Foreign Application Priority Data
May 17, 2006 (DE) 10 2006 023 136.8

(51) Int. Cl. G07C 5/08

(52) U.S. Cl. 701/35

(57) ABSTRACT

A digital tachograph (12) has a data storage medium apparatus for accommodating a data storage medium (CARD). The digital tachograph (12) is arranged in a motor vehicle (2). If the data storage medium (CARD) is in the data storage medium apparatus, the data storage medium (CARD) is automatically authenticated (AUTH) and/or identified in a manner triggered by the ignition (IGN) of the motor vehicle (2) being switched on and/or by the motor vehicle (2) stopping (STOP).

### CROSS-REFERENCE TO RELATED APPLICATIONS

This application is a U.S. National Stage Application of International Application No. PCT/EP2007/054507 filed May 10, 2007, which designates the United States of America, and claims priority to German Application No. 10 2006 023 136.8 filed May 17, 2006, the contents of which are hereby incorporated by reference in their entirety.

### TECHNICAL FIELD

The invention relates to a method and an apparatus for operating a digital tachograph. The digital tachograph has a data storage medium apparatus for holding a data storage medium. The digital tachograph is arranged in a motor vehicle. The invention also relates to a method and an apparatus for operating the data storage medium. The data storage medium is arranged in the data storage medium apparatus in the tachograph.

### BACKGROUND

Legal regulations mean that, by way of example, professional drivers need to record driving times and driving speeds, for example, which they have reached in covering distances with a motor vehicle in a professional capacity. To this end, motor vehicles regularly contain tachographs. The tachographs have data storage medium apparatuses for holding at least one data storage medium. The driving times and the driving speeds are then written to the data storage medium by the tachograph. The data storage medium may be a chip card, for example.

DE 197 50 771 A1 discloses a tachograph arrangement for use in a vehicle, particularly a motor vehicle. The tachograph arrangement has means for sensing driving states of the vehicle and for obtaining driving state data, driving state storage means for storing the driving state data, a device for inputting driver data in association with a journey or a journey section, driver data storage means for storing the driver data, and memory access means for allowing driving state and driver data from at least one journey section to be read. The driver data input device has identification means for identifying the driver from physical features, particularly during a journey state, and for outputting identification data.

### SUMMARY

A method and an apparatus for operating a digital tachograph and a data storage medium can be provided which easily allow convenient use of the digital tachograph and of the data storage medium.

According to an embodiment, a method for operating a data storage medium which is arranged in a data storage medium apparatus in a tachograph, wherein turning on the ignition of the motor vehicle and/or stopping the motor vehicle prompts the tachograph to be automatically authenticated and/or identified.

According to a further embodiment, the tachograph can be automatically authenticated and/or identified after a prescribed first period after the ignition of the motor vehicle is turned on or after the motor vehicle is stopped. According to a further embodiment, the tachograph can be treated as authentic for a prescribed second period after successful authentication of the tachograph. According to a further embodiment, data can be automatically interchanged between the tachograph and the data storage medium only after successful authentication or after identification.

According to another embodiment, an apparatus for operating a data storage medium which is arranged in a data storage medium apparatus in a tachograph and is supplied with power by the tachograph, may be designed to automatically authenticate and/or identify the tachograph when prompted by the ignition of the motor vehicle being turned on and/or when prompted by the motor vehicle being stopped.

### BRIEF DESCRIPTION OF THE DRAWINGS

The invention is explained in more detail below with the aid of schematic drawings, in which:

FIG. 1 shows a motor vehicle,

FIG. 2 shows a timing diagram,

FIG. 3 shows a first program for operating the tachograph, and

FIG. 4 shows a second program for operating the tachograph.

Elements of the same design or function are identified by the same reference symbols across the figures.

### DETAILED DESCRIPTION

According to a first aspect, in a method and an apparatus for operating a digital tachograph, the digital tachograph has a data storage medium apparatus for holding a data storage medium and is arranged in a motor vehicle. If the data storage medium is in the data storage medium apparatus, turning on the ignition of the motor vehicle and/or stopping the motor vehicle prompts the data storage medium to be automatically authenticated and/or identified.

This may be conducive to the data storage medium being able to be released very quickly when the data storage medium is requested by a driver of the motor vehicle, in particular shortly after the ignition of the motor vehicle is turned on or shortly after the vehicle is stopped.

According to a second aspect, in a method and an apparatus for operating the data storage medium, the data storage medium can be arranged in the data storage medium apparatus of the tachograph and turning on the ignition of the motor vehicle and/or stopping the motor vehicle prompts the tachograph to be automatically authenticated and/or identified. This may be conducive to the data storage medium being able to be released very quickly when the data storage medium is requested by the driver of the motor vehicle shortly after the ignition of the motor vehicle is turned on or shortly after the vehicle is stopped. In addition, this allows the tachograph to be authenticated or identified. The data storage medium is preferably a chip card whose chip has at least a memory unit and preferably at least a computation unit.

In one refinement of the first and/or second aspect, the data storage medium and the tachograph are automatically authenticated and/or identified after a prescribed first period after the ignition of the motor vehicle is turned on or after the motor vehicle is stopped. This may be conducive to avoiding unnecessary authentication, particularly when the vehicle is stopped briefly, for example at a red light.

In another refinement of the first and/or second aspect, the data storage medium and the tachograph are treated as authentic for a prescribed second period after the successful authentication of the data storage medium and the tachograph. This makes it possible for the driver not to need to request the data storage medium immediately after the ignition of the motor vehicle is turned on or after the vehicle is stopped and nevertheless for the data storage medium to be released quickly. In this context, the fact that the data storage medium is treated as authentic means that the data storage medium is treated as though the authentication has been performed successfully in real time.

In another refinement of the first and/or second aspect, data are automatically interchanged between the tachograph and the data storage medium only after successful authentication or after successful identification. This is conducive to no data being interchanged with an unauthenticated or unidentified data storage medium or tachograph.

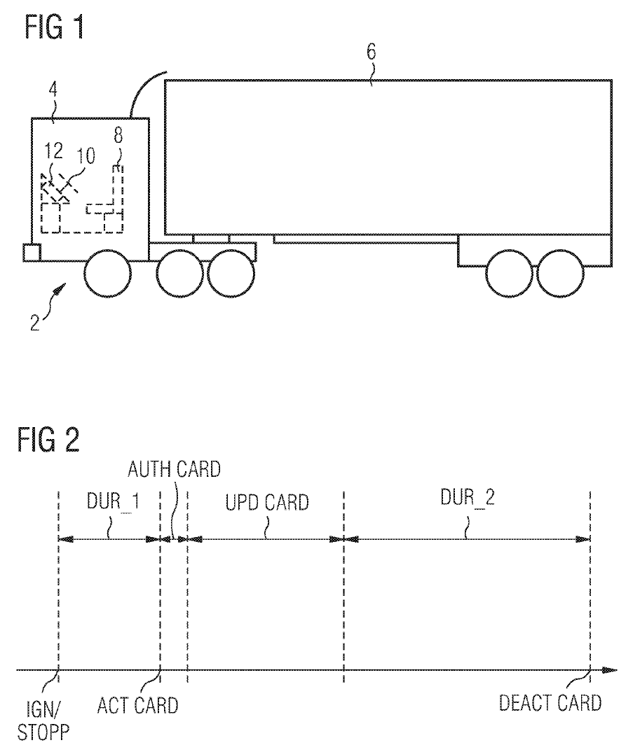

A motor vehicle 2 (FIG. 1) comprises a driver's cab 4 and, by way of example, a trailer 6. The driver's cab 4 contains at least one vehicle seat 8 and a steering wheel 10. In addition, the driver's cab 4 has a dashboard which comprises at least one tachograph 12. Alternatively, the tachograph 12 may be a standalone appliance which can be connected to a tachometer in the motor vehicle 2.

The tachograph 12 has a data storage medium apparatus. The data storage medium apparatus is suitable for holding a data storage medium. The data storage medium is preferably a chip card CARD. The chip card CARD has a computer chip which preferably comprises at least one computation unit and a memory unit. If the chip card CARD is supplied with power in a suitable fashion, the computation unit in the chip card can execute programs which are stored in the memory unit in the chip card CARD, for example. As an alternative to the chip card CARD, another data storage medium with or without a computation unit may also be used.

The tachograph 12 can store driving data for the motor vehicle 2 on the chip card CARD. The driving data comprise a driving period, a driving speed and/or driving times, for example. The driving times are a starting time or an ending time for the relevant journey, for example. In addition, information about the driver of the motor vehicle 2 may be stored on the chip card, for example. The tachograph may comprise two data storage medium apparatuses, for example, into which a respective chip card CARD of the driver or a passenger in a motor vehicle 2 can be inserted. When there is a change of driver, the chip cards CARD are then preferably exchanged. Alternatively, a switch may be provided on a tachograph 12 which makes it possible to change over from the chip card CARD of the driver to the chip card CARD of the passenger.

Before data can be interchanged between the chip card CARD and the tachograph 12, the chip card CARD and/or the tachograph 12 need to be authenticated AUTH and/or identified (FIG. 2). In this connection, that is to say that the tachograph 12 and the chip card CARD check the chip card CARD and the tachograph 12, respectively, to determine whether the tachograph 12 and the chip card CARD are authentic, i.e. in this context that the chip card CARD and the tachograph 12 are not forgeries and are provided for this use by the legislator and/or by the relevant manufacturer.

The authentication AUTH can take between a few seconds and a few minutes. If the driver now begins a journey or if the change of driver takes place or if the journey is ended then the chip card CARD needs to be regularly arranged in the data storage medium apparatus and regularly removed from the data storage medium apparatus. When the chip card CARD has been requested by the driver, the chip card CARD and the tachograph 12 are first of all authenticated AUTH and/or identified and then the data are interchanged. So that the driver does not need to wait for an unnecessary length of time for the chip card CARD to be released, provision is made for turning on the ignition IGN of the motor vehicle of an internal combustion engine in the motor vehicle 2 and/or stopping STOP the motor vehicle 2 to prompt the chip card CARD and the tachograph 12 to be automatically authenticated AUTH or identified.

Preferably, a prescribed first period DUR_1, for example one to five minutes, is awaited after the authentication AUTH is prompted until the authentication AUTH or identification is performed. This may be conducive, by way of example, to preventing the authentication AUTH from being performed unnecessarily when a vehicle is stopped STOP at a red light or in a tailback.

In addition, the authentication AUTH is preferably maintained and the chip card CARD treated as authentic for a prescribed second period DUR_2 after the authentication AUTH or identification. This allows the driver of the motor vehicle 2 to be able to park the motor vehicle 2 in his own time, possibly to be able to leave it briefly and then still be able to quickly release his chip card CARD. Following the authentication AUTH of the chip card CARD or of the tachograph 12, the data on the chip card CARD are updated UPD, preferably automatically. The automatic updating UPD may thus also be conducive to accelerated release of the chip card CARD.

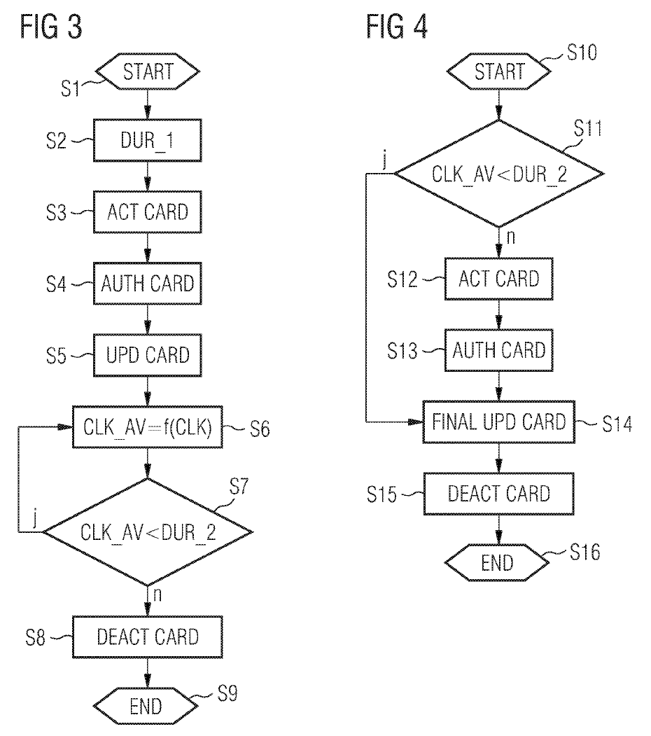

A first program (FIG. 3) for operating the tachograph 12 is preferably stored in a storage medium in the tachograph 12. The first program is used to authenticate AUTH and/or to identify the chip card CARD automatically and to maintain the authentication AUTH during the second period DUR_2 after the authentication AUTH. The first program is preferably started at a time close to when the ignition IGN of the motor vehicle 2 is turned on in a step S1. In the step S1, variables are possibly initialized.

In a step S2, there is a pause for a prescribed first period DUR_1. The prescribed first period DUR_1 may be one to five minutes, for example.

In a step S3, the chip card CARD is activated ACT.

In a step S4, the chip card CARD is automatically authenticated AUTH and/or identified.

In a step S5, the data on the chip card CARD are automatically updated UPD.

In a step S6, a time CLK_AV since the authentication AUTH of the chip card CARD is ascertained, for example on the basis of a clock time CLK.

In a step S7, a check is performed to determine whether the time CLK_AV since the authentication AUTH is shorter than the second period DUR_2. The second period DUR_2 may be ten minutes, for example. If the condition in step S7 is met, the processing is continued again in step S6. If the condition in step S7 is not met, the processing is continued in a step S8.

In step S8, the chip card CARD is deactivated DEACT.

In a step S9, the first program can be terminated.

The flowchart for the first program can readily be transferred to a flowchart for a first program which is executed by the computation unit on the chip card CARD supplied with power for the purpose of authenticating AUTH the tachograph 12. The first program on the chip card CARD is started when the chip card CARD is activated in step S3 of the first program. In step S4, the tachograph 12 is authenticated AUTH or identified and not the chip card CARD. The first program on the chip card CARD is preferably terminated when the chip card CARD is deactivated DEACT.

In addition to the first program, a second program (FIG. 4) is preferably stored on a storage medium in the tachograph 12. The second program is used to allow the chip card CARD to be released quickly. The second program is preferably started when the chip card CARD is requested by the driver of the motor vehicle 2 in a step S10. In step S10, variables are possibly initialized.

In a step S11, a check is performed to determine whether the time CLK_AV since the last authentication AUTH is shorter than the prescribed second period DUR_2. If the condition in step S11 is not met, the processing is continued in a step S12. If the condition in step S11 is met, the processing is continued in a step S14.

In step S12, the chip card CARD is activated ACT.

In a step S13, the chip card CARD is authenticated AUTH and/or identified.

In step S14, the data on the chip card CARD are finally FINAL updated UPD automatically.

In a step S15, the chip card CARD is deactivated DEACT.

In a step S16, the second program can be terminated.

As an alternative and/or in addition, the second program can also be executed in the computation unit of the chip card CARD, in which case the activation ACT of the chip card CARD in step S12 of the second program is omitted and is used as a prompt to start the second program on the chip card CARD. In addition, step S15 is omitted, in which case the deactivation of the chip card CARD by the tachograph 12 in step S16 is the prompt to terminate the second program. In addition, in step S13, the tachograph 12 is then authenticated AUTH or identified.

The invention is not limited to the exemplary embodiment indicated. By way of example, the tachograph 12 may be arranged in any desired motor vehicle with or without a trailer 6. Furthermore, the first and second programs may be implemented in one program. In addition, only the tachograph 12 or only the chip card CARD can be authenticated AUTH or identified.

What is claimed is:

1. A method for operating a data storage medium which is arranged in a data storage medium apparatus in a tachograph, the method comprising the step of prompting the tachograph to be automatically at least one of authenticated and identified by:
at least one of turning on the ignition of the motor vehicle and stopping the motor vehicle.

2. The method according to claim 1, wherein the tachograph is automatically at least one of authenticated and identified after a prescribed first period after the ignition of the motor vehicle is turned on or after the motor vehicle is stopped.

3. The method according to claim 1, wherein the tachograph is treated as authentic for a prescribed second period after successful authentication of the tachograph.

4. The method according to claim 1, wherein data are automatically interchanged between the tachograph and the data storage medium only after successful authentication or after identification.

5. An apparatus for operating a data storage medium which is arranged in a data storage medium apparatus in a tachograph and is supplied with power by the tachograph, wherein the apparatus is operable to automatically at least perform one of authenticate and identify the tachograph when prompted by the ignition of the motor vehicle being turned on or when prompted by the motor vehicle being stopped.

6. The apparatus according to claim 5, wherein the apparatus is further operable to automatically to perform at least one authentication and identification of the tachograph after a prescribed first period after the ignition of the motor vehicle is turned on or after the motor vehicle is stopped.

7. The apparatus according to claim 5, wherein the apparatus is further operable to treat the tachograph as authentic for a prescribed second period after successful authentication of the tachograph.

8. The apparatus according to claim 5, wherein the apparatus is further operable to automatically interchange data between the tachograph and the data storage medium only after successful authentication or after identification.

9. An apparatus for operating a data storage medium which is arranged in a data storage medium apparatus in a tachograph and is supplied with power by the tachograph, wherein the apparatus is operable to automatically at least perform one of authenticate and identify the tachograph when prompted by the ignition of the motor vehicle being turned on and the motor vehicle being stopped.

10. The apparatus according to claim 9, wherein the apparatus is further operable to automatically to perform at least one authentication and identification of the tachograph after a prescribed first period after the ignition of the motor vehicle is turned on or after the motor vehicle is stopped.

11. The apparatus according to claim 9, wherein the apparatus is further operable to treat the tachograph as authentic for a prescribed second period after successful authentication of the tachograph.

12. The apparatus according to claim 9, wherein the apparatus is further operable to automatically interchange data between the tachograph and the data storage medium only after successful authentication or after identification.
